(19) United States
(12) Patent Application Publication
(10) Pub. No.: US 2023/0281217 A1
(43) Pub. Date: Sep. 7, 2023

(54) SYSTEMS AND METHODS FOR A GRAPHICAL USER INTERFACE FOR DATA ANALYSIS AND VISUALISATION

(71) Applicant: Tercen Data Analytics Limited, Waterford (IE)

(72) Inventors: Faris NAJI, Waterford (IE); Martin ENGLISH, Waterford (IE); Alexandre MAUREL, Waterford (IE)

(21) Appl. No.: 18/178,283

(22) Filed: Mar. 3, 2023

Related U.S. Application Data
(60) Provisional application No. 63/316,638, filed on Mar. 4, 2022.

(51) Int. Cl. G06F 16/26; G06F 3/0482; G06F 9/451

(52) U.S. Cl. CPC G06F 16/26; G06F 3/0482; G06F 9/451

(57) ABSTRACT

Systems and methods are described herein for providing a graphical user interface for data analysis comprising the steps of displaying a data workflow diagram containing an element indicative of an uploaded data set; and creating a new step in the data workflow (hereafter a new ‘datastep’) from either the uploaded data set or data of an intermediate datastep.

### CROSS-REFERENCE TO RELATED APPLCIATION(S)

This is application is a nonprovisional application claiming benefit to U.S. Pat. Application No. 63/316,638, filed on Mar. 4, 2022, which is incorporated herein by reference in its entirety.

### FIELD OF THE DISCLOSURE

Various embodiments of the present disclosure pertain generally to systems and methods for graphical user interfaces. More specifically, particular embodiments of the present disclosure relate to systems and methods for a graphical user interface for data analysis and visualization.

### BACKGROUND OF THE INVENTION

Data analysis is the process of cleaning, manipulating, inspecting, and modelling raw data with the view to gain insight or discover meaning in the raw data. In the modern world, data analysis is becoming a driving force in decision making for businesses and governments worldwide. With this being the case, it is necessary that any analysis performed can be inspected and tweaked, as any minor errors in any step of an analysis process can perpetuate throughout the analysis leading to potentially incorrect results and as a consequence, incorrect conclusions being drawn from the raw data.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### BRIEF SUMMARY OF THE INVENTION

According to certain aspects of the present disclosure, the systems and methods described herein provides for a method of providing a graphical user interface for data analysis (such as from a biological system) and a corresponding computer and server for the same. That method comprising the steps of displaying a data workflow diagram containing an element indicative of an uploaded data set and creating a new step in the data workflow (hereafter a new ‘datastep’) from either the uploaded data set or data of an intermediate datastep. The creation is done by displaying in a datastep window a list of headers (often referred to as attributes or factors) of data available to the new datastep including those of the uploaded data set and any intermediate datasteps; displaying in the datastep window a table having a primary row header, a primary column header, at least one nestled row header, at least one nestled column header and a table body; in response to a user selecting by dragging and dropping headers from the list of headers on to the primary and/or nestled row and column headers, and displaying in the body of the table a corresponding projection of data accordingly to the selected headers which may be updated after each header selection by the user Once created, an element indicative of that new datastep is displayed in the workflow diagram.

With this approach, a data workflow is represented by the population of a workspace with elements which represents the availability of datasets for display or calculation (individually, datasteps). With the present graphical user interface, individually datasteps can be readily configured by a user based on the available datasets.

The datastep window may further include a menu from which the user can select an operation to be applied to at least some of the data of the listed headers. Where this is the case, the selected operation may be applied only to data of user selected headers or only to projected data.

The selected operation may create new, derivative data with corresponding new data headers from data of the listed headers (e.g., using relational algebra). Such new data may be projected in the body of the table in the datastep window of that datastep. Also, such new data headers may be selected in a datastep window of any subsequently created datastep downstream in the data workflow. Any new data may be further operated upon in a subsequently created datastep downstream in the data workflow.

In the workflow diagram, relationship elements (e.g. connecting lines) can be displayed which indicate the relationship between created datasteps and the uploaded data set and/or an intermediate datastep from which they was created.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 shows, schematically, a data workflow diagram of a graphical user interface, according to techniques presented herein;

FIGS. 2 to 6 show, schematically, datastep windows for configuring datasteps of the data workflow of FIG. 1, according to techniques presented herein;

FIG. 7 shows, schematically, a modified data workflow diagram of a graphical user interface, according to techniques presented herein; and

FIG. 8 shows, schematically, a datastep window for configuring datastep ‘STEP 4’ of the data workflow of FIG. 7, according to techniques presented herein.

FIG. 9 shows an exemplary data workflow diagram for using immunology measurements from a cytometer, according to techniques presented herein.

FIG. 10 shows an exemplary graphical representation of FIG. 9, according to techniques presented herein.

FIG. 11 shows the function of a data analysis operator, a data analysis gather operator, and a data analysis join operator, according to techniques presented herein.

### DETAILED DESCRIPTION OF THE INVENTION

Traditionally in data analysis, raw data is uploaded into analysis software, the raw data may then be manipulated through the use of various functions before plotting either the raw data or the manipulated data to provide visualization, for example, a graph.

In conventional data analysis software, data is typically presented in a table or matrix and functions can be performed on some or all of the rows/columns of the data to gain insight, producing yet further tables or matrices containing manipulated data. With large data sets, and/or in situations where the analysis of the data requires multiple complex steps, it can become difficult to keep track of what has been done. There exists a need for improved visualization and control over the steps in data analysis processes.

Furthermore, it is often the case that data analysis and manipulation is completed before the result of the said analysis is plotted as a graph or other visual. This method is limiting, however, as it tends to limit the data analysis to a step-by-step path from raw data to result. This traditional way of working, therefore, misses the possibility of finding unexpected links between data sets and/or variables within a data set. Further, it lends itself away from making speculative analyses due to the end-goal orientated nature of the process. This could lead to insights being missed. Therefore, there exists a need for faster more intuitive systems and methods for data analysis that moves away from the goal orientated way of thinking, whilst remaining structured and understandable. Understandable here relating to how easy it is to tell from looking at the data analysis software what steps have been carried out to which data set.

An additional problem in the field of data analysis is that of scalability. With large data sets and multiple steps of data analysis to be executed, large amounts of computing power is required to perform the analysis. Especially in the case that each new step in the analysis depends on the results of one or more previous steps. There is a need in the art of a more computationally and storage efficient data analysis package to deal with such a situation.

Some examples of data analysis include an analysis method for large and/or complex biological data sets from molecular biology experiments comprising importing data in a table data structure, comparing data points, calculating an optimized data representation and displaying the representation.

Some examples of data analysis include techniques facilitating using flow graphs to represent a data analysis program in a cloud-based system for open science collaboration and discovery. In an example, a system can represent a data analysis execution as a flow graph where vertices of the flow graph represent function calls made during the data analysis program and edges between the vertices represent objects passed between the functions. In another example, the flow graph can then be annotated using an annotation database to label the recognized function calls and objects. In another example, the system can then semantically label the annotated flow graph by aligning the annotated graph with a knowledge base of data analysis concepts to provide context for the operations being performed by the data analysis program.

Existing data analysis packages do not allow for an intuitive way of performing additional analysis on data that has already been plotted into a visualization.

In the following description, like features are given like numerals.

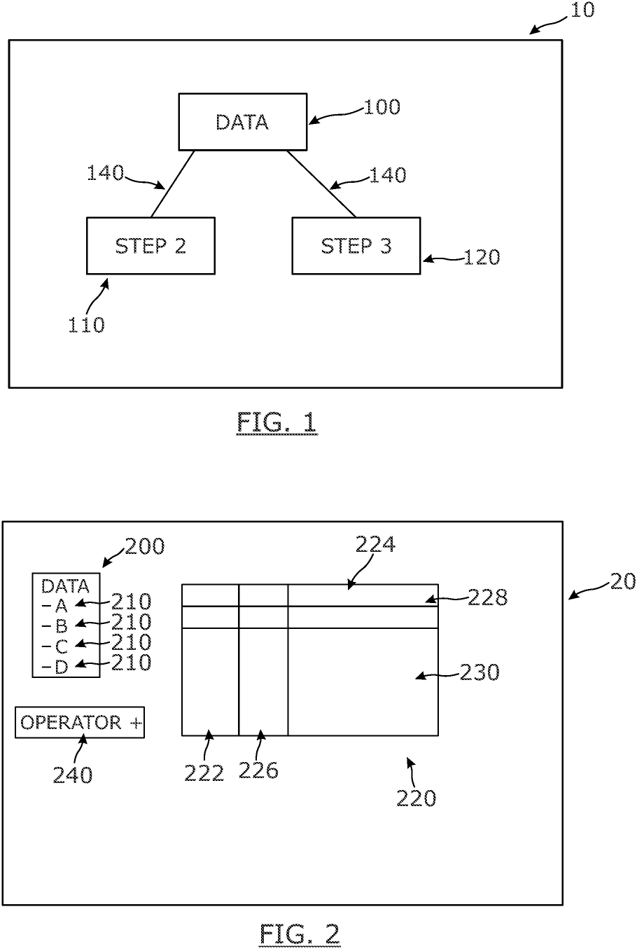

FIG. 1 shows a data workflow diagram 10 of a graphical user interface having a rectangular box 100 labelled ‘DATA’ which is representative of an uploaded data set 100 and which, in the context of a data workflow, can be considered to be an initial or first datastep 100). Also shown in the data workflow diagram are second and third rectangular boxes 110, 120 labelled ‘STEP 2’ & ‘STEP 3’ which is representative of further datasteps in a data workflow. The workflow diagram contains connecting lines, which indicate the respective relationships of datastep ‘STEP 2’ and datastep ‘STEP 3’ to the uploaded data set/first data step ‘DATA’. As will be further described below, the datastep ‘STEP 2’ is used to visualize the data of the uploaded data set/first data step 100 and the third datastep (step 3) is an operand resulting from an operation applied to the uploaded data set/ datastep ‘DATA’.

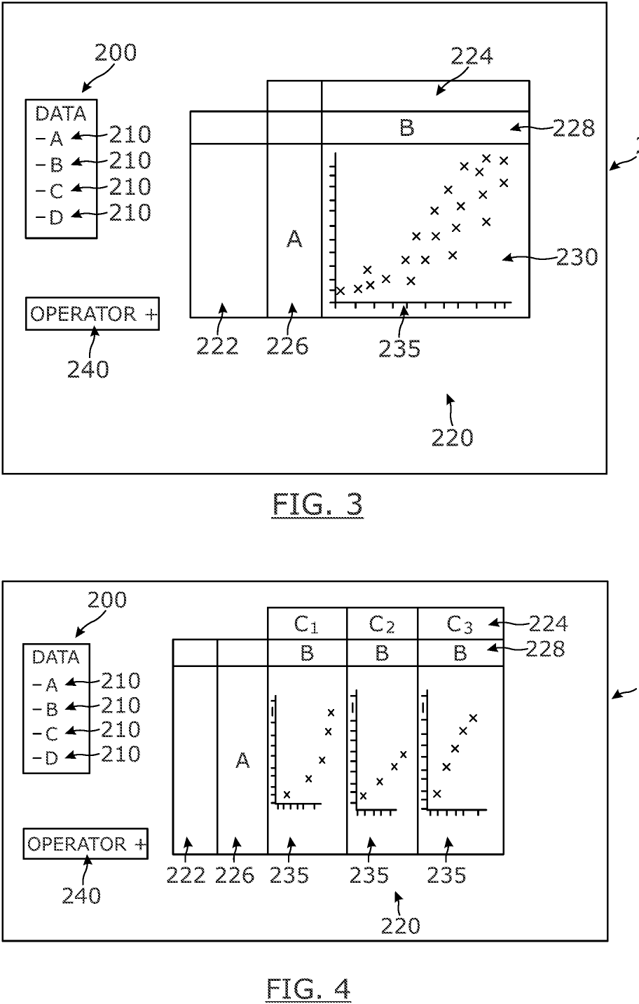

FIG. 2 shows an unconfigured datastep window 20 of a graphical user interface which can be used by a user to configure a datastep based on datastep ‘DATA’, i.e., the uploaded data set. The datastep window contains a rectangular box 200 labelled ‘DATA’ which contains a list of selectable headers of data A to D 210 which is that have been extracted from datastep ‘DATA’. The datastep window further contains a blank table 220 having a primary row header 224, a primary column header 226, a nestled row header 228, a nestled column header 226 and a table body 230. These might alternatively be referred to as a row zone 220, a column zone 224, a Y axis zone 226, and X axis zone 228 and a plot area 230. To visualize data of datastep ‘DATA’, a user can select headers of data 210 (labelled A to D) by dragging and dropping selected headers on to the primary and/or nestled row and column headers. Such selection results in the projection of data according to the selected headers in the body of the table as exemplified below in FIGS. 3 to 5. Also shown in the datastep window is a rectangular box 240 labelled ‘Operator+’ which when selected reveals a list of available data operations which may be applied to the data available to the datastep, and thus is an operation selection menu 240, again as exemplified below in FIG. 6.

FIG. 3 shows a datastep window after a first exemplary user configuration for datastep ‘STEP 2’ provides, as mentioned, a visualising of data of datastep ‘DATA’ located upstream of datastep ‘STEP 2’ in the data workflow diagram. Specifically, datastep window 20 is show after the user has dragged header ‘A’ into nestled column header/Y axis zone 226 and dragged header ‘B’ into nestled row header/X axis zone 228. In this example, A is a dependent variable and B is an independent variable. As a result of the user selecting headers by positioning headers A & B 210 in the table 220 in this way, header A data is plotted against header B data in the body of the table 230.

FIG. 4 shows a datastep window after a second exemplary user configuration for datastep ‘STEP 2’ providing an alternative visualising of data of datastep ‘DATA’. As with the example of FIG. 3, datastep window 20 is shown after the user has dragged header ‘A’ into nestled column header/y axis zone 226 and dragged header ‘B’ into nestled row header/X axis zone 228. In addition, the datastep window 20 is further show after the user has dragged header ‘C’ into the primary row header/row zone 224. In this example, A is a dependent variable, B is an independent variable, C is a sample name and D is a run number. I.e. a measurement is taken of A against B, for sample C and repeated D times. As a result of this user configuration, data of header A is plotted against data of header B for each sample C. This results in a plurality of plots 235 in the plot area 230, one for each of the samples measured.

FIG. 5 shows a datastep window after a third exemplary user configuration for datastep ‘STEP 2’ providing an further alternative visualising of data of datastep ‘DATA’. As with the example of FIG. 4, datastep window 20 is shown after the user has dragged header ‘A’ into nestled column header/y axis zone 226, dragged header ‘B’ into nestled row header/X axis zone 228 and dragged header ‘C’ into the primary row header/row zone 224. In addition, the datastep window 20 is further show after the user has dragged header ‘D’ into the primary column header/column zone 222. In addition, the datastep window 20 is further show after the user has dragged header ‘D’ into the primary row header/row zone 224 so as to cause the projection to present data from each run separately. I.e. one for each instance of D for each of the samples measured.

FIG. 6 shows a datastep window after user configuration for datastep ‘STEP 3’, providing, as mentioned, an operand resulting from an operation applied to the uploaded data set/ datastep ‘DATA’. As with the example of FIG. 3, datastep window 20 is shown after the user has dragged header ‘A’ into nestled column header/y axis zone 226 and dragged header ‘B’ into nestled row header/X axis zone 228. In addition, the datastep window 20 is further shown after the user has selected the operator ‘MEAN’ using the operation menu 240 as a result of which the mean of header A data is plotted against the mean of header B data in the body of the table 230. Note, as the data projection in the body of the table is updated after each user selection, the display of the body may first be that of FIG. 3 before selection of the operator ‘MEAN’ and changing to that of FIG. 6. Indeed, as the user drags further headers or results into the zones of the table, the plot may preferably be replotted.

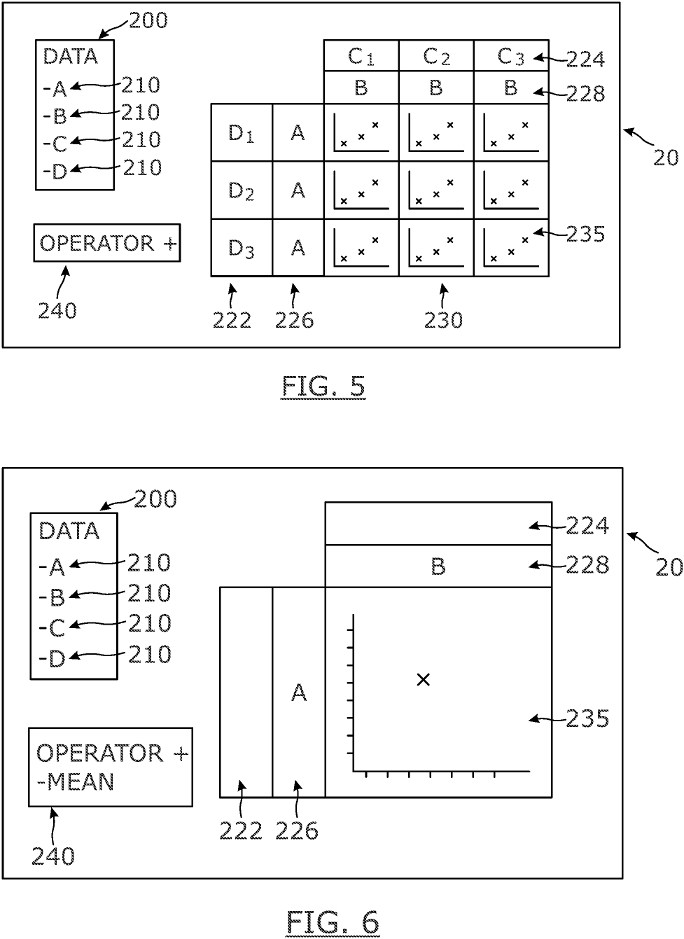

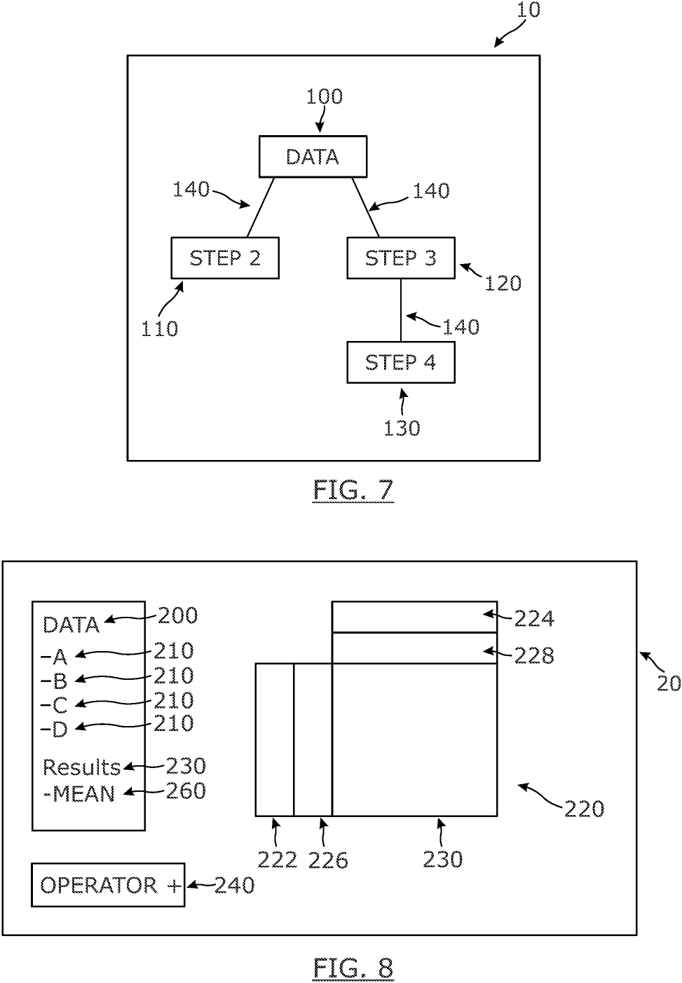

FIG. 7 shows a data workflow diagram 10 based on that of FIG. 1 but including new datastep ‘STEP 4’ 130 based on datastep ‘STEP 3’ as configured above with the upstream /downstream relationship indicated by connecting line 140. Datastep ‘STEP 4’ can be user configured with the datastep window of FIG. 8 which, as compared to the datastep windows of FIGS. 3 to 6, further includes the ‘MEAN’ data header 260 in the header list corresponding to data calculated using the MEAN operator in datastep ‘STEP 3’. The data of the MEAN data header is available to the user in datastep ‘STEP 4’ along with the data headers of datastep ‘STEP 1’/the uploaded data set by virtue of being downstream of datastep ‘STEP 1’ and datastep ‘STEP 3’ in the data workflow. Thus, in datastep ‘STEP 4’, the user may configure a projection using data of the MEAN data header in combination with data of any of data headers A to D. In datastep ‘STEP 4’, the user may also apply an operation to data of the MEAN data header in combination with data of any of data headers A to D to create further derivative data which would be available to the user downstream of datastep ‘STEP 4’.

Alternative operators may include functions which provide mathematical functions such as calculations of median, mode, standard deviations or which provide data manipulation functions such as sorting, grouping and removal of anomalies.

As mentioned above, with this approach, a data workflow is represented by the population of a workspace with elements which represent the availability of datasets for display or calculation (individually, datasteps). With the present graphical user interface, individual datasteps can be readily configured by a user based on the available datasets. Also, the fact that a datastep window for any newly created datastep can comprise a list of results of any operations upstream of the additional datastep in the workflow diagram allows for multiple operations to be successively applied. I.e., for derivative data created in a datastep to be an operand for a further operation. Results which are the subject of successful operations can also be projected in downstream datasteps. Operators can be applied such that they take into account the user selection of header. For example, the MEAN described above could be applied as the mean per row.

When initially creating a data workflow and following a user uploading one or more data sets to the workflow diagram, the only datasteps present in the workflow diagram will be the uploaded datasets. The user can then add datasteps with the view that each datastep can be used to process a step in the data analysis path. Therefore, the user may add one or more datasteps, then select one of the added datasteps to perform a data analysis step. The one or more datasteps that are associated with the uploaded data may be demarked with an indicator that shows that they are the starting points, i.e., the most upstream datasteps in the workflow diagram. The indicator may be a small shape present in the datastep, preferably in the corner of the datastep, or a word such as ‘start’ or ‘data’ for example.

The datastep window for any given datastep may further include a filter zone. The filter zone may be configured such that the user may drag and drop a header or result into the filter zone to apply a filter to the data that is represented by the header or result. The filtered data will then be represented by a result within the datastep window, so that the user may drag and drop the filtered data into the table to produce a plot. The filter zone may include a filter selection tool allowing the user to select what type of filter to be applied. The filters available to the user may be, but are not limited to, a bandpass filter, NaN filter, etc.

Also, the datastep window may comprise a label zone, the label zone may be configured such that the user may drag and drop a header or result into the label zone and apply a label to the data represented by the header or result. This will result in a new result including the labelled data.

The datastep window may comprise a colour zone. The colour zone may be configured such that the user may drag and drop a header or result into the colour zone and apply a colour to the data. This will result in the creation of a new result with the colour applied to the data. If the user were to drag this new result into one of the zones of the table of the datastep window then the data would be plotted in the applied colour.

Opening the datastep window provides means to select the desired analysis for each datastep. The datastep window comprises: a list of the headers of any data sets upstream from the selected datastep, a table, the table comprising a plurality of zones, the zones comprising at least an x-axis zone, a y-axis zone, a row zone, and a column zone. Additional datasteps are associated with one or more of the existing data steps. Associated with here meaning that the datasteps are connected in the workflow path. The association may be indicated through the use of lines or arrows.

Providing a graphical visualisation of the data is generally perceived to be the end product of data analysis, with all manipulation and mathematical analysis of the data having occurred prior to graphing. However, the systems and methods described herein provides the possibility of continuing analysis based on the graphed data. This provides improved visualisation of the analysis process, allowing a user to see what the data looks like at each step of the analysis process. This takes a step away from the standard methods of doing data analysis and provides a solution where the data is automatically provided in a visual representation at each step, removing the need to separately plot the data. In other words, rather than the analysis and plotting being separate activities as is the case in traditional data analysis, in the systems and methods described herein, the two are interlinked to remove the steps of plotting the data, and to make the results of each analysis step immediately available. Not only does this improve transparency in the data analysis by making it easy to return to any data step simply by opening the datastep window associated with it to see what analysis has taken place, it also makes error finding and error correction easier as the data is plotted at every step making it easier to spot an error. Further, if an error is made, and a datastep is changed to correct the error, the change will automatically be applied to all downstream datasteps in the workflow diagram by virtue of their association. This association is preferably implemented using relational algebra.

The program may further be configured so that the user may rearrange the datasteps in the workflow diagram. This provides the user with the option to arrange the datasteps to optimise readability.

Alternatively or in addition, the program may automatically arrange the workflow diagram in response to a new datastep being added. This ensures that the workflow is automatically arranged in a legible manner.

When a new datastep is added, the datastep may be associated with an existing datastep. For example, the program may be configured such that a user may select an existing datastep and choose to add a new datastep to the workflow diagram that is associated with said selected datastep.

Any given datastep will have in its associated datastep window, at least the data from and the results of any operations performed in all of the associated datasteps upstream of the given data step. This allows for analysis to be performed on the results of previous analysis, allowing for more conclusions to be drawn from the uploaded data.

A newly added datastep may be associated with more than one existing datastep in the workflow diagram. As such, the program may be configured such that any datastep can be linked (associated) with any other data step. The user may choose to associate a datastep with other datastep. The data steps may be linked by a user selecting one or more data steps and choosing to associate them.

As previously mentioned, any given datastep will have in its associated datastep window, at least the data from and the results of any operations performed in all of the associated datasteps upstream of the given data step. By allowing for a datastep to be associated with more than one other datastep, more flexibility for analysis is obtained as results from analysis from separate datasets can be combined and plotted together to gain further insight.

When a datastep is linked to two or more upstream data sets, the program may be configured to automatically determine a degree of correlation between each of the two or more data sets. The results of this automatic analysis may be made available to the user in the datastep window of the datastep that is linked to the two or more upstream datasets.

The degree of correlation may be determined through curve fitting or scatter analysis.

The program may use relational algebra to perform the analysis along the workflow path, this allows for improved scalability over traditional methods and as a result the systems and methods described hereincan analyse larger datasets more efficiently.

A header may also be referred to as an attribute or a factor. This terminology comes from the field of relational algebra.

A table may be referred to as a relation. Again this terminology comes from the field of relational algebra. A table is a relation, a set of Tables is also a relation. A single table may be referred to as a ‘Simple Relation’. Two or more tabled joined together may be referred to as a ‘Composite Relation’. A relation may therefore be defined as an ensemble of one or more connected tables. A dataset is an instance of a table, and therefore also a relation.

A relation is a set of attributes. An attribute has a name and a type (numeric, character, etc.).

A relation can be represented as a table where each attribute will be converted into a column. If the user drags and drops headers (attributes) and/or results into the table in a datastep window to create a projection, this defines a new relation that would be the input of the desired computation. The execution of a datastep generates a new relation linking the input relation and the operator relations (The operator relations are results of the computation.).

Similarly if the user drags or drops the headers (attributes) and/or results into the colour zone, label zone or filter zone if present, this defines a new relation. Put another way, when a user drags and drops headers (attributes) into any of the zones in the datastep window, this defines a new relation that would be the input of the desired computation. The execution of a datastep generates a new relation linking the input relation and the operator relations. This new relation may be called a cross-table relation. It is composed of select and a distinct relation and allows the labelization of attributes. The labelization is the giving abstract labels such as (y-axis, x-axis, rows, cols, color, label) to the universal table. These labels are used by the operators to calculate the results.

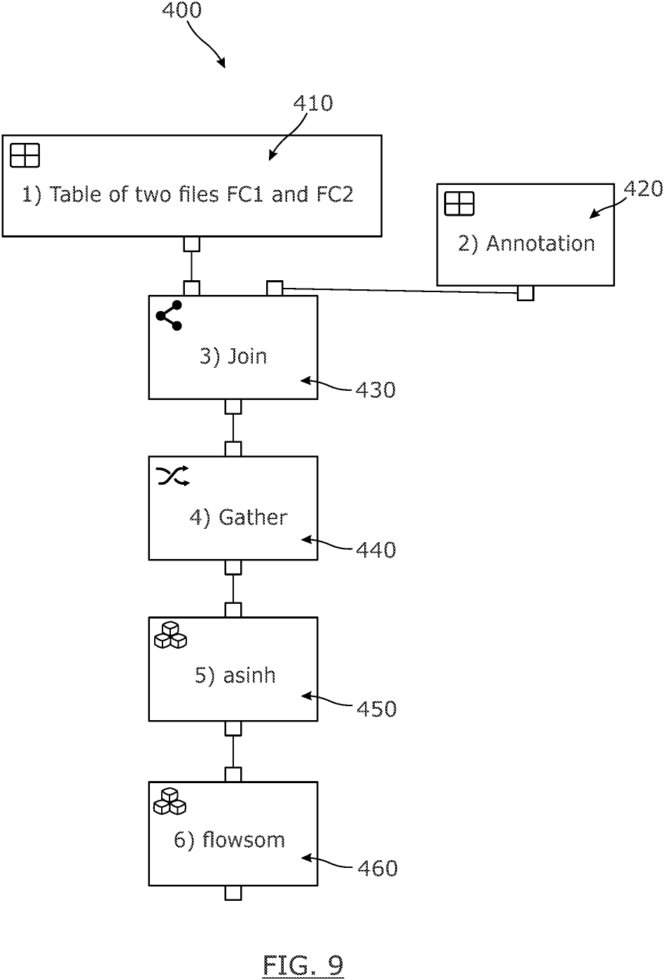

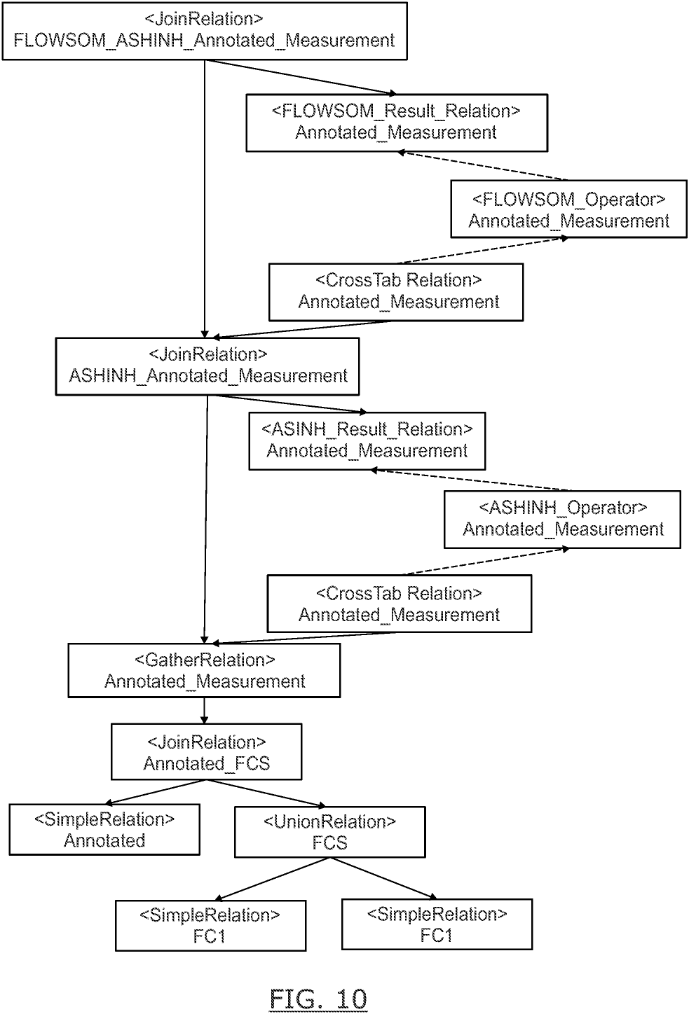

FIG. 9 is an example of a data workflow diagram for using immunology measurements from a cytometer and FIG. 10 is a corresponding representation of the above algebra in a graph structure (noting that the graph starts at the bottom and goes upwards, the opposite direction to the workflow representation). The data workflow has six steps represented with the data analysis algebra described below:
Step 1) 410 in GUI
   FCS1 = SimpleRelation(filename, measurement1, measurement2)
   FCS2 = SimpleRelation(filename, measurement1, measurement2)
   FCS = UnionRelation(FCS1, FCS2)
Step 2) 420 in GUI
   Annotation = SimpleRelation(filename, attrA, attrB)
Step 3) 430 in GUI
   Annotated_FCS = JoinRelation(FCS, Annotation, [filename])
Step 4) 440 in GUI
   Annotated_Measurement = GatherRelation(Annotated_FCS, [measurement1, measurement2])
Step 5) 450 in GUI
   ASINH_Projection = CrosstabRelation(Annotated_Measurement, row(variable), column(filename, rowld), y(value))
   ASINH_ResultRelation = ASINH_Operator(ASINH_Projection) ⇒ SimpleRelation(variable, filename, rowld, ASINH_value)
   ASINH_Annotated_Measurement = JoinRelation(Annotated_Measurement,
   ASINH_ResultRelation, [variable, filename, rowld])
Step 6) 460 in GUI
   FLOWSOM_Projection = CrosstabRelation(ASINH_Annotated_Measurement, row(variable), column(filename, rowld), y(ASINH_value) )
   FLOWSOM_ResultRelation = FLOWSOM_Operator(FLOWSOM_Projection) ⇒ SimpleRelation(filename, rowld, cluster_id)
   FLOWSOM_ASINH_Annotated_Measurement = JoinRelation(ASINH_Annotated_Measurement, FLOWSOM_ResultRelation, [filename, rowld])

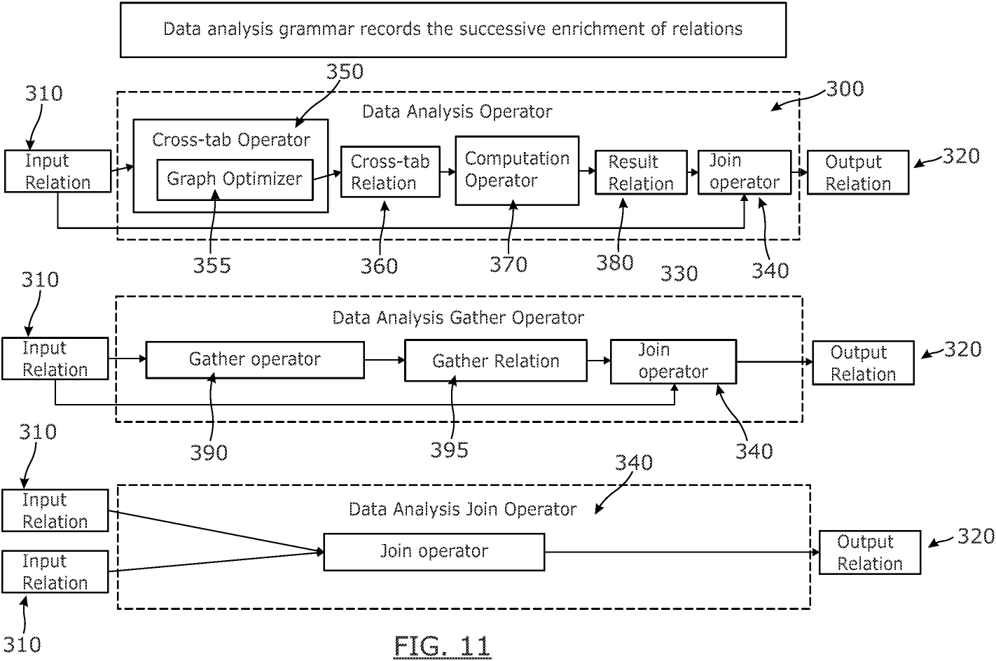

FIG. 11 shows the function of the data analysis operator 300, the data analysis gather operator 330 and the data analysis join operator 340. The Data analysis operator 300 takes in an input relation 310 and subjects said input relation 310 to the cross-tab operator 350. The cross tab operator applies the graph optimiser 355 to the input relation 310. This produces a cross tab relation 360. The data analysis operator then applies a computation operator 370 to the cross-tab relation 360 to produce a result relation 380. The data analysis operator 300 then passes the result relation 380 and the input operation 310 to the join operator 340 to produce the output relation 320 of the data analysis operator. The data analysis gather operator 330 takes in an input relation 310 and applies the gather operation 390 to produce a gather relation 395. The data analysis gather operator 330 then passes the gather relation 395 and the input relation 310 to the join operator 340 to produce an output relation 320. The Data analysis join operator 340 takes in two input relations 310, these input relations are preferably different and applies the join operator 340 to the two input relations to produce an output relation 320.

A relation is an abstract class which is implemented by the following example classes: Simple Relation, InMemory Relation, Composite Relation, Gather Relation, Union Relation, Rename Relation, Group Relation, Where Relation, Pairwise Relation and Gather Variable Relation.

There are different types of relations to embed different types of relational algebra operators which is to be able to define a data analysis algebra. Also, relational algebra may be used to perform the analysis along the workflow path whereby the processor may be configured such that all relations which are connected in the workflow diagram are tracked and recorded (this concept may be referred to as deep linking); and the processor may “universalise” all relations in a workflow diagram into one large relational (called Universal relation) by joining all connected relations. This has the benefit of presenting a simplified interface for any data manipulation. The universal relation represents a complete linkage of the result to the input through the intermediate steps. By creating a universal relation in this way, systems and methods described herein may bemore computationally efficient than existing data analysis packages that do not use deep linking.

The processor may be configured such that it can implement one or more different types of relations to embed different types of relational algebra operators. This is done to be able to define a data analysis algebra. Below are examples of how different types of relation may be represented and/or stored:

SimpleRelation: Store data as a table in persistent data storage.
SimpleRelation(attrA, attrB, attrC, attrD, attrE, attrF)
InMemoryRelation: Store data as a table in memory.
InMemoryRelation(attrA, attrB, attrC, attrD, attrE, attrF)
CompositeRelation: A relation that implements the Snowflake schema pattern. A
snowflake schema being a logical arrangement of tables in a multidimensional
database such that the entity relationship diagram resembles a snowflake shape.
CompositeRelation(SimpleRelation(attrA, attrB, attrC, attrD, attrE, attrF),
SimpleRelation(attrA, attrB, attr01), [attrA, attrB])
GatherRelation: A relation that merges multiple attributes into one. This is implemented
in an innovative approach using a union relation and a set of select relations. A gather
relation allows for reshaping a relation from “wide” to “long”. The long format allows for
combining multiple attributes into one attribute. This relation can be expressed using
union and select relations.
GatherRelation(SimpleRelation(A,B,C,D), [B,C,D])
===>
UnionRelation(GatherVariableRelation(SimpleRelation(A,B,C,D), B),
GatherVariableRelation (SimpleRelation(A,B,C,D), C),
GatherVariableRelation (SimpleRelation(A,B,C,D), D))
UnionRelation(GatherVariableRelation
(WhereRelation(SimpleRelation(A,B,C,D), D = 42 ), B),
GatherVariableRelation(SimpleRelation(A,B,C,D), C),
GatherVariableRelation(SimpleRelation(A,B,C,D), D))
relation.select([A,B]) ⇒ Table(A,B)
where = WhereRelation(SimpleRelation(A,B,C,D), A = 1)
where.select(C,D) ⇒ Table(C,D)
UnionRelation: A relation that concatenates rows of multiple relations into one.
UnionRelation([
SimpleRelation(ID1, attrA, attrB, attrC, attrD, attrE, attrF),
SimpleRelation(ID2, attrA, attrB, attrC, attrD, attrE, attrF)
])
RenameRelation: A relation that renames one or more attributes.
RenameRelation(SimpleRelation(attrA, attrB), )
WhereRelation: A relation that filters rows of another relation.
CrosstabRelation: A relation that labels attributes of an input relation to create a
crosstab projection. Available labels are row, column, y, x, color, label

A data analysis operator is a function that takes a CrosstabRelation as input and computes a new relation, this new relation is then joined to the crosstab parent (i.e input) relation using a CompositeRelation and returned. Example:

InputRel is the input relation defined as followed
InputRel = SimpleRelation(attrA, attrB, attrC, attrD, attrE, attrF)
A crosstab projection named CR, is created:
CR = CrosstabRelation( InputRel, row(attrA) , column(attrB), y(attrC))
In this example the MeanOperator is aggregating data using the “row” and “column”
labels, and compute the mean of the factor labeled by “y”, the result is stored into a
SimpleRelation named ResultRel:
ResultRel = MeanOperator(CR) = SimpleRelation(attrA, attrB, meanAttr)
The OutputRel relation joined the input relation to result
OutputRel = CompositeRelation(InputRel, ResultRel, [attrA, attrB])
The OutputRel relation has the following attributes: attrA, attrB, attrC, attrD, attrE, attrF,
meanAttr. This OutputRel relation can now become the input of another data analysis
step.

A data analysis algebra graph optimizer can rewrite the data analysis graph algebra to simplify a schema which may be used to simplify the universal relation to reduce the computing power and storage required to perform efficient data queries. For example, consider a ‘SimpleRelations’ which is a Table and it has two headers (cols) called attrA and attrB. An example of this graph rewriter transform the following relation:
Before the graph rewriter:
   WhereRelation(UnionRelation(SimpleRelation(attrA, attrB),
   SimpleRelation(attrA, attrB)), “attrB == 42”)
After the graph rewriter:
   UnionRelation(WhereRelation(SimpleRelation(attrA, attrB), “attrB == 42”),
   WhereRelation(SimpleRelation(attrA, attrB), “attrB == 42”))

Some of the optimization procedures which may be applied to the graph to increase the performance of the total query: Remove Unused Relation, Rename Rids, Revert Join, GatherTo Union, Distinct Relation, Where Gather Variable, Where Gather Value, Remove Singular Union, Remove Useless Distinct, Remove Rids Distinct and Merge Where.

In respect of math algebra, the optimizer optimise a calculation. For example, a * b + a * c = a * (b + c). Also, A + 0 = A (adding a zero is similar to doing nothing). In a further example:

Fact = SimpleRelation(A,B)
Dim = SimpleRelation(AA,BB)
JoinRel = JoinRelation(Fact, Dim, [A,AA])
JoinRel = JoinRelation(SimpleRelation(A,B), SimpleRelation(AA,BB), [A,AA])
Dim2 = SimpleRelation(D,F)
JoinRel2 = JoinRelation(JoinRel, Dim2, [A,D])
JoinRel2 = JoinRelation(JoinRelation(SimpleRelation(A,B), SimpleRelation(AA,BB),
[A,AA]), SimpleRelation(D,F), [A,D])

What is claimed is:

1. A method of providing a graphical user interface for data analysis comprising:
displaying a data workflow diagram containing an element indicative of an uploaded data set; and
creating a new step in the data workflow (hereafter a new ‘datastep’) from either the uploaded data set or data of an intermediate datastep by:
displaying in a datastep window a list of headers of data available to the new datastep including those of the uploaded data set and any intermediate datasteps;
displaying in the datastep window a table having a primary row header, a primary column header, at least one nestled row header, at least one nestled column header and a table body;
in response to a user selecting by dragging and dropping headers from the list of headers on to the primary and/or nestled row and column headers, displaying in the body of the table a corresponding projection of data accordingly to the selected headers; and
displaying in the workflow diagram an element indicative of that new datastep.

2. The method of claim 1 wherein, the projection is updated after each header selection by the user.

3. The method of claim 1, wherein the datastep window further includes a menu from which the user can select an operation to be applied to at least some of the data of the listed headers.

4. The method of claim 3, wherein the selected operation is applied only to data of user selected headers.

5. The method of claim 3, wherein the selected operation is applied only to projected data.

6. The method of claim 3, wherein the selected operation creates new, derivative data with corresponding new data headers from data of the listed headers.

7. The method of claim 6, wherein the new data is projected in the body of the table in the datastep window of that datastep.

8. The method of claim 6, wherein the new data headers may be selected in a datastep window of any subsequently created datastep downstream in the data workflow.

9. The method of claim 6, wherein the new data may be further operated upon in a subsequently created datastep downstream in the data workflow.

10. The method of claim 6, wherein the new data is created using relational algebra.

11. The method of claim 1, wherein the datastep window further includes a menu from which the user can select a filter to specify a configuration or format of the data projection.

12. The method of claim 1, wherein dragging and dropping a header allows the user to select if the data associated with the header is to be plotted as a dependent or independent variable.

13. The method of claim 1, wherein relationship elements are displayed in the workflow diagram which indicate the relationship between created datasteps and the uploaded data set and/or an intermediate datastep from which they were created.

14. The method of claim 13, wherein the relationship elements are connecting lines.

15. The method of claim 1, wherein the uploaded data set comprises data from a biological system.

16. A system for processing a graphical user interface, the system comprising:
at least one memory storing instructions; and
at least one processor configured to execute the instructions to perform operations comprising:
displaying a data workflow diagram containing an element indicative of an uploaded data set; and
creating a new step in the data workflow (hereafter a new ‘datastep’) from either the uploaded data set or data of an intermediate datastep by:
displaying in a datastep window a list of headers of data available to the new datastep including those of the uploaded data set and any intermediate datasteps;
displaying in the datastep window a table having a primary row header, a primary column header, at least one nestled row header, at least one nestled column header and a table body;
in response to a user selecting by dragging and dropping headers from the list of headers on to the primary and/or nestled row and column headers, displaying in the body of the table a corresponding projection of data accordingly to the selected headers; and
displaying in the workflow diagram an element indicative of that new datastep.

17. A non-transitory computer-readable medium storing instructions that, when executed by a processor, perform operations processing a graphical user interface, the operations comprising:
displaying a data workflow diagram containing an element indicative of an uploaded data set; and
creating a new step in the data workflow (hereafter a new ‘datastep’) from either the uploaded data set or data of an intermediate datastep by:
displaying in a datastep window a list of headers of data available to the new datastep including those of the uploaded data set and any intermediate datasteps;
displaying in the datastep window a table having a primary row header, a primary column header, at least one nestled row header, at least one nestled column header and a table body;
in response to a user selecting by dragging and dropping headers from the list of headers on to the primary and/or nestled row and column headers, displaying in the body of the table a corresponding projection of data accordingly to the selected headers; and
displaying in the workflow diagram an element indicative of that new datastep.
